(19) United States
(12) Patent Application Publication
(10) Pub. No.: US 2004/0068903 A1
(43) Pub. Date: Apr. 15, 2004

(54) 3-D patterned frame for a light string

(76) Inventor: Yi-Ming Chin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/270,361

(22) Filed: Oct. 15, 2002

(51) Int. Cl. G09F 1/08

(52) U.S. Cl. 40/538; 40/540

(57) ABSTRACT

The present invention relates to a 3-D patterned frame for a light string, which includes a cylindrical frame connected with four legs bottomly and with an animal head frame at front opening. The head frame can be received in the cylindrical frame and the legs can be folded when the patterned frame is not used. That becomes a small volume for easily moved and stored

### BACKGROUND OF THE INVENTION

A conventional patterned frame is always a 2-D (plan) structure for a light string to hang on, which shows the patterned shape of lighting decorative effect. This 2-D design is monotonous. An improved 3-D patterned frame is provided for increasing the decorative effect. But such 3-D patterned frame has a fixed structure, which is inconvenient to be moved or stored.

Accordingly, the primary object of the invention is to provide a 3-D patterned frame being an animal outlook for a light string, which can be folded and received to be a small volume for facilitating in storage. Now the features and advantages of the present invention will be described in detail with reference to the accompanying drawings.

### BRIEF DESCRIPTION OF ACCOMPANYING DRAWINGS

FIG. 1 is a plan view showing an assembled 3-D patterned frame for a light string according to the present invention.

FIG. 2 is a perspective view of parts of FIG. 1.

FIG. 3 is a perspective view of FIG. 1 showing rear legs of the animal frame.

FIG. 4 is a view of FIG. 1 when to receive its head portion into its cylindrical body.

FIG. 5 is a view of FIG. 1 when to fold its rear legs beside its cylindrical body.

FIG. 6 is a perspective view showing a modified embodiment according to the present invention.

### DETAILED DESCRIPTION OF PREFERRED EMBODIMENTS

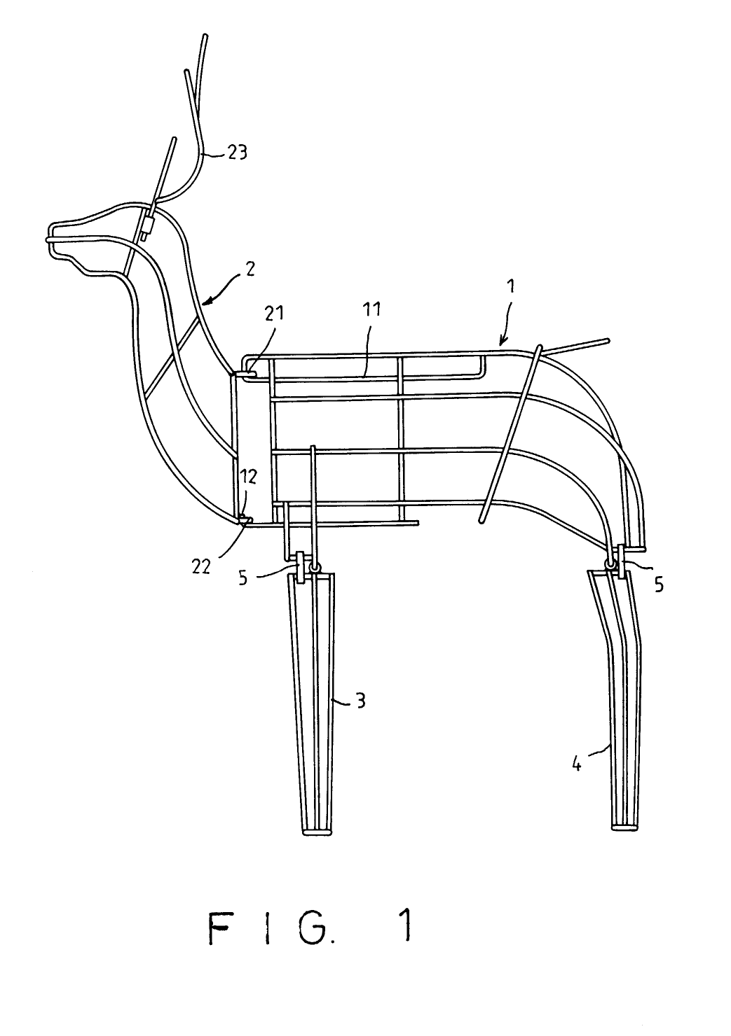

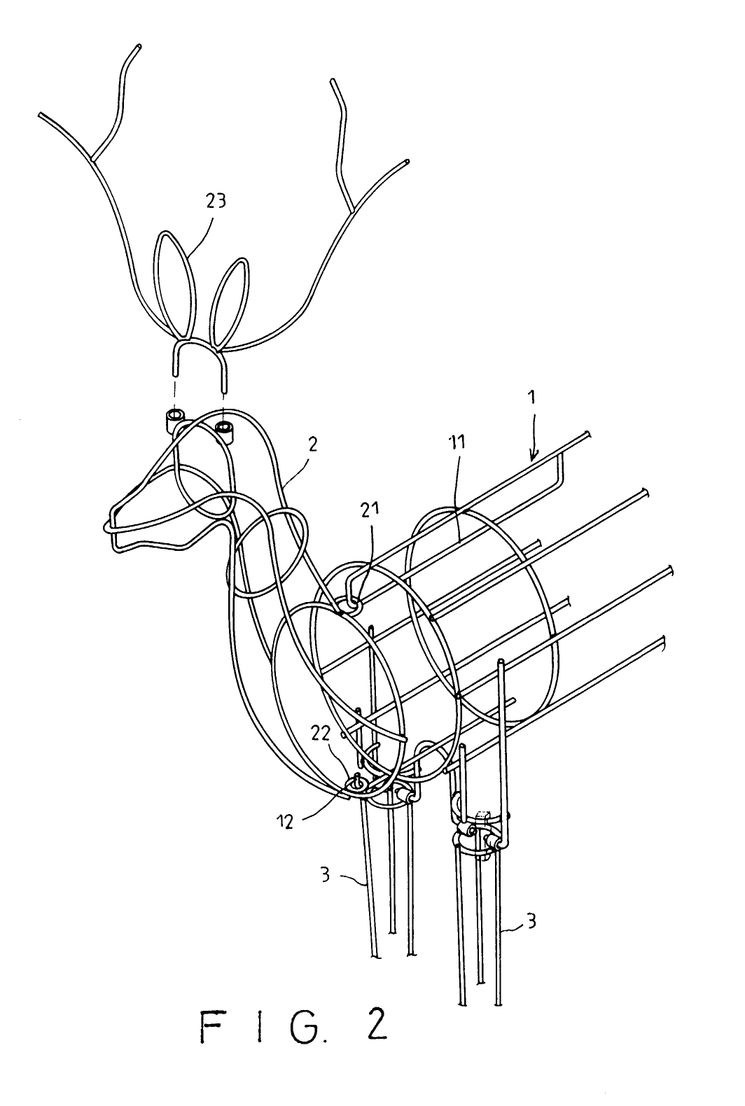

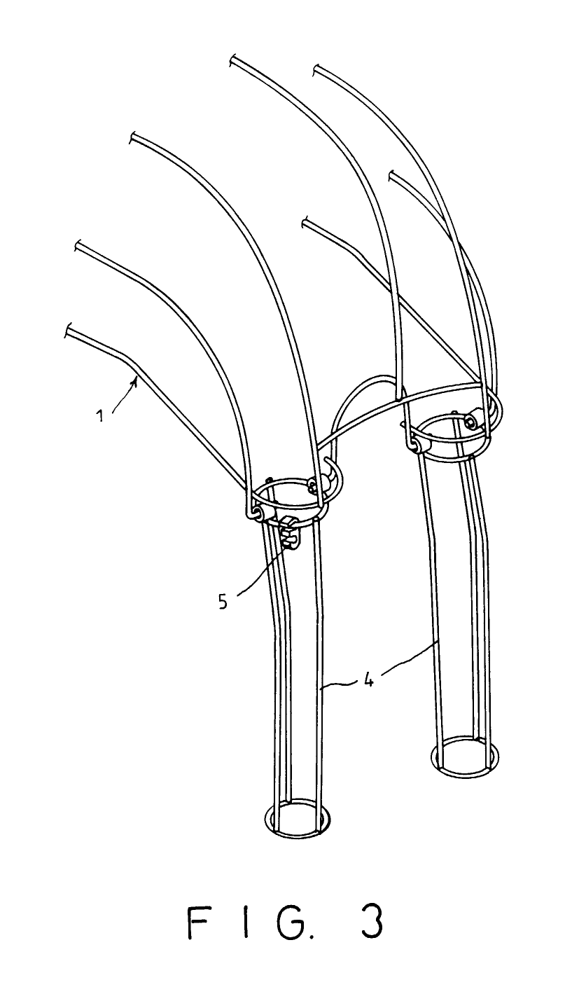

Please refer to FIG. 1 to 3, the present invention is a 3-D patterned frame for a light string, which includes a cylindrical frame (1), an animal head frame (2), two front legs (3), and two rear legs (4). The cylindrical frame (1) is provided with an upper rod (11) and with a positioning beam (12) at lower portion of its front opening. The front legs (3) and rear legs (4) are pivoted with the cylindrical frame (I) bottomly. The head frame being an animal shape is provided with an upper ring (21) and a lower ring (22), wherein the upper ring (21) is put around the rod (11) and the lower ring (22) can be placed around the beam (12). So the head animal frame (2) is connected with the cylindrical frame (1) in stable manner. A decorative horn (23) can also be connected with the head frame (2) to obtain a perfect decoration being similar to a real one.

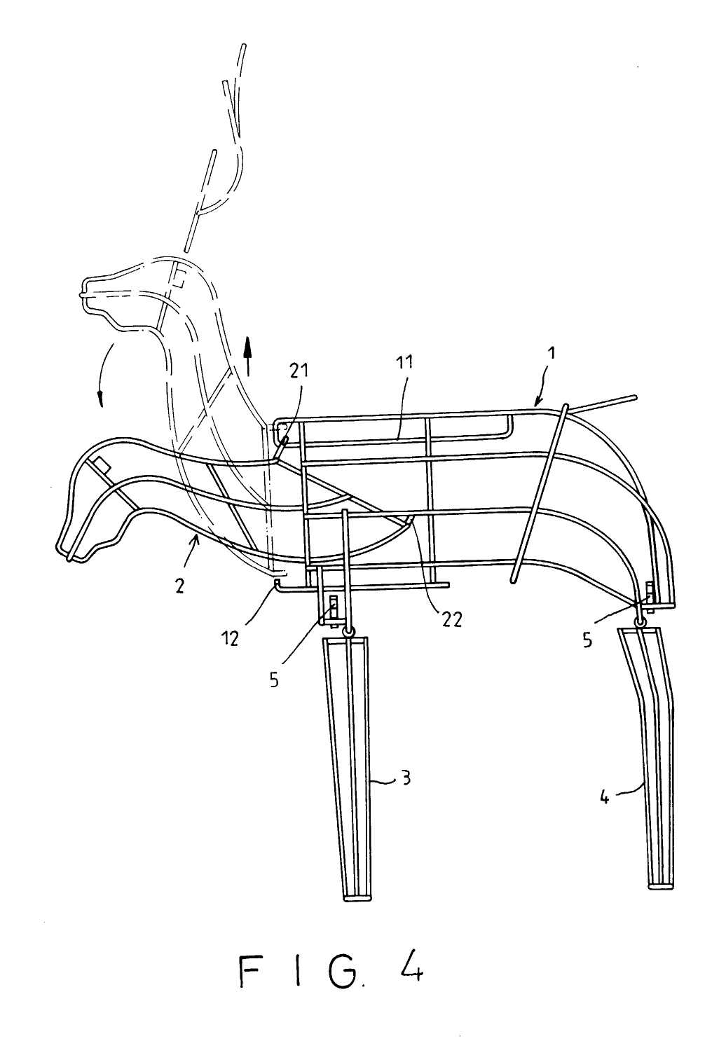

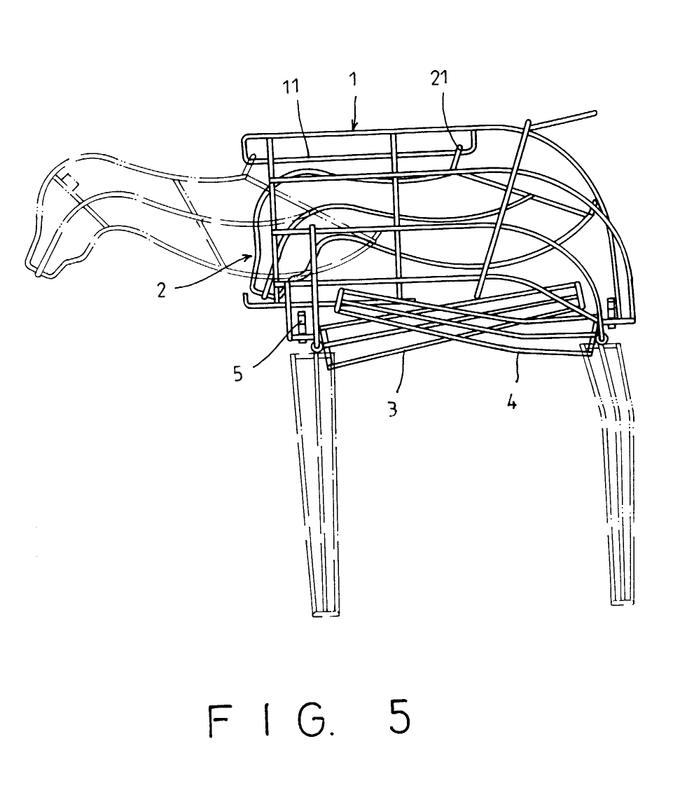

When to store the patterned frame, the decorative horn (23) is removed firstly. Then, the animal head frame (2) is lifted up for moving the lower ring (22) away from the beam (12). The head frame (2) can be received in the cylindrical frame (1) while the upper ring (21) is moved along to rod (11), as shown in FIG. 4. It can be found that the front and rear legs (3), (4) are connected with the cylindrical frame (1), wherein a hook (5) is used for connecting respectively. When to fold the legs (3), (4), the hook (5) is released firstly from the cylindrical frame (1) and then the legs can be folded as shown in FIG. 5.

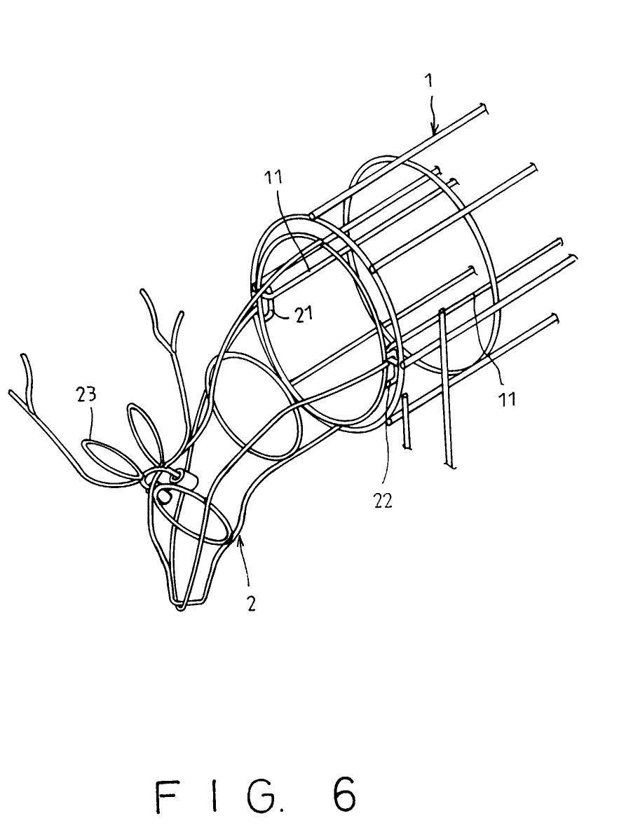

Accordingly, the present invention provides a 3-D patterned frame for a light string with a better lighting effect. It can be received and folded to become a small volume when it is not used that facilitates the patterned frame to be moved and stored with improvements. Under the aforesaid technique, the FIG. 6 shows a modified embodiment according to the present invention, wherein the cylindrical frame has two rods (11) provided at both sides while the head frame has two rings (21), (22) provided at related sides. It achieves a similar utility and improvement.

What is claimed is:

1. A 3-D patterned frame for a light string including a cylindrical frame, an animal head frame, two front legs, and two rear legs, wherein the cylindrical frame being provided with an upper rod and with a positioning beam at lower portion of its front opening; the front and rear legs being pivoted with the cylindrical frame bottomly, the head frame being an animal shape provided with an upper ring and a lower ring, wherein the upper ring is put around the rod and the lower ring is placed around the beam that the head animal frame is connected with the cylindrical frame in stable manner.

2. The 3-D patterned frame for a light string as claimed in claim 1, wherein a decorative horn can be connected with the head frame to obtain a perfect decoration being similar to a real one.

3. The 3-D patterned frame for a light string as claimed in claim 1, wherein the decorative horn is removed firstly and then the animal head frame is lifted up for moving the lower ring away from the beam; the head frame being received in the cylindrical frame while the upper ring is moved along to rod.

4. The 3-D patterned frame for a light string as claimed in claim 1, wherein the front and rear legs are connected with the cylindrical frame, wherein a hook is used for connecting respectively, as to fold the legs, the hook being released firstly from the cylindrical frame and then the legs are folded.
